(19) United States
(12) Patent Application Publication
(10) Pub. No.: US 2010/0064699 A1
(43) Pub. Date: Mar. 18, 2010

(54) REFRIGERATION-GENERATION SOLAR UNIT FOR AN AIR-CONDITIONING SYSTEM, HEAT-GENERATION SOLAR UNIT, CORRESPONDING DEVICES AND CORRESPONDING CONTROL METHOD

(76) Inventor: Gérard Llurens, Saint Paul (FR)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/095,651

(22) PCT Filed: Nov. 30, 2006
(86) PCT No.: PCT/EP06/69176

§ 371 Date: Sep. 2, 2009

(30) Foreign Application Priority Data
Nov. 30, 2005 (FR) 0512185

(51) Int. Cl. F25B 7/00; F25B 27/00; F25B 15/00; F24J 2/30; F25B 41/00; F25D 17/02; G05B 15/00

(52) U.S. Cl. 62/79; 62/235.1; 62/476; 126/643; 62/513; 62/434; 700/275

(57) ABSTRACT

A refrigeration-generation solar unit is provided for an air-conditioning system. The system includes a first heat exchanger comprising: absorption machine including a boiler and evaporator, the evaporator including at least a second heat exchanger, and the boiler including at least a third heat exchanger; a plurality of solar collectors; a first cooling fluid circuit between the first heat exchanger and the second heat exchanger; and a second heat-transfer fluid circuit between the third heat exchanger and the plurality of solar collectors. The second circuit includes a circulation pump supplying heat-transfer fluid to the plurality of solar collectors and a temperature sensor to measure the temperature of the heat-transfer fluid at the outlet of the plurality of solar collectors. The solar unit includes varies the operational delivery rate of the circulation pump according to the fluid temperature recorded by the temperature sensor at the outlet of the plurality of solar collectors.

### CROSS-REFERENCE TO RELATED APPLICATIONS

This Application is a Section 371 National Stage Application of International Application No. PCT/EP2006/069176, filed Nov. 30, 2006 and published as WO 2007/063119A1, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of air conditioning systems using solar energy. More specifically, the disclosure relates to a self-contained refrigeration unit running throughout the year exclusively or primarily on solar energy, and which has been provided with a control device so as to ensure satisfactory average energy performances of the unit over at least a portion of the diurnal period.

### BACKGROUND OF THE DISCLOSURE

The use of solar energy to produce refrigeration has already been the subject of technological developments for a number of decades. The implementation of such technological equipment can make it possible to significantly reduce power consumption associated with the increasing use of air conditioning in living premises, offices or commercial premises, which of course has an impact on economic balance, energy independence and also on environmental preservation, in particular in geographic regions with a high percentage of possible sunshine.

Among the various technological solutions possible, the use of absorption means, also called absorption refrigeration machines, shortened to absorption machines, powered by heat absorbed by solar collectors, is recognized as one of the most promising possibilities.

The development and distribution of refrigeration units based on such absorption refrigeration machines have however been adversely affected by the high cost of their production, in particular due to the high cost of solar collectors. The time required before a return on investment of such units is currently estimated at several decades.

A second known disadvantage of these refrigeration units is of course that their operation is dependent on periods of sunshine.

A first prior art technique suggests combining such a unit with a complementary device supplying heat to the boiler-forming means in the absorption machine, for example a gas or fuel boiler burner, or an electrical heating resistor so as to compensate for periods of insufficient sunshine.

A second technique consists of collecting heated water by an electrical resistor in a storage tank during off-peak periods for power consumption in order to restore it during periods of insufficient sunshine. In any case, the disadvantage of depending on the percentage of possible sunshine normally leads to the consideration that the solar energy supply can constitute only an added heat supply. Moreover, it is generally agreed that the use of solar energy is made more difficult by the fact that the temperature levels reached are lower than the temperatures obtained with a burner or an electrical resistor.

Furthermore, an additional problem is that of making it possible to reduce the startup periods of such refrigeration units to suitable periods.

A first known technical solution suggests the use of vacuum solar collectors, of which the thermal performance makes it possible to heat the fluid circulating in the collectors to temperatures above those reached in other types of solar collectors so as to counter the thermal inertia resulting from the warm-up of the fluid circuit of the refrigeration unit.

However, this technical solution leads to an increase in the cost of the refrigeration unit.

Another technical solution known from the prior art consists of preheating the fluid circulating in the absorption machine by means of the aforementioned added heat supply systems.

In general, the implementation of known techniques leads to an additional production cost for the refrigeration unit and makes this unit less robust, more complex to control, and therefore less reliable.

In other words, the known techniques are expensive and/or energy-consuming if acceptable performances are to be maintained, and are therefore unsatisfactory.

### SUMMARY

An aspect of the disclosure is directed to a solar-powered refrigeration unit for an air conditioning system, which system comprises at least a first heat exchanger comprising:

absorption means comprising boiler-forming means and evaporator-forming means, in which the evaporator-forming means comprise at least one heat exchanger and the boiler-forming means comprise at least a third heat exchanger;

a plurality of solar collectors;

a first coolant circuit between the first heat exchanger and the second heat exchanger; and

a second heat transfer fluid circuit between the third heat exchanger and the plurality of solar collectors, in which the second circuit comprises at least a circulator pump supplying heat transfer fluid to the plurality of solar collectors, and at least a temperature sensor intended to measure the temperature of the heat transfer fluid at the outlet of the plurality of solar collectors.

According to an embodiment of the invention, such a solar-powered refrigeration unit comprises means for varying the operational flow rate of the circulator pump on the basis of the temperature of the fluid obtained by the temperature sensor at the outlet of the plurality of solar collectors.

Thus, an embodiment of the invention proposes a self-contained refrigeration unit for an air conditioning system running solely on solar energy.

The control of the system is also simple and reliable, since it is implemented on the basis of a single temperature measurement point. In addition, by acting on the operational flow rate of the circulator pump and not on valves placed on the second heat transfer fluid circuit, malfunctions related to a poor fluid balancing in the branches of the fluid circuit are largely prevented.

Advantageously, the second heat transfer fluid circuit comprises at least one bypass with a first branch comprising at least the circulator pump and a second branch, and at least one valve acting on the fluid flow circulating in the second branch of the bypass.

The valve acting on the bypass thus makes it possible to direct the heat transfer fluid leaving the solar collectors directly to the inlet of these collectors in order to accelerate the heating of the heat transfer fluid. This valve also allows control of the temperature of the heat transfer fluid circulating to the boiler-forming means.

The valve is preferably of the full-on/full-off three-way valve or cut-off valve type.

It is thus possible to direct the entire fluid flow into the branch of the bypass by means of a three-way valve or a plurality of cut-off valves.

According to an advantageous embodiment of the invention, the second heat transfer fluid circuit comprises at least means forming a heat transfer fluid collection tank, and at least one three-way valve with a progressive opening making it possible to distribute the operational flow rate between the boiler-forming means of the absorption means and the means forming the heat transfer fluid collection tank.

These energy storage means thus make it possible to extend the time of operation of the system to periods of insufficient sunshine. Moreover, the three-way valve with a progressive opening makes it possible to ensure that the heat transfer fluid arriving in the collection tank is at the temperature required for use.

Advantageously, the second heat transfer fluid circuit comprises at least one second circulator pump making it possible to circulate the heat transfer fluid from the means forming the heat transfer fluid collection tank to the boiler-forming means.

Thus, the supply of heat transfer fluid to the boiler-forming means is possible even if the at least one valve directs all of the heat transfer fluid coming from the plurality of solar collectors into the bypass branch.

Advantageously, the plurality of solar collectors comprises at least two solar collectors associated in series and at least two groups of solar collectors associated in parallel.

Such an arrangement of the solar collectors thus makes it possible to obtain a temperature increase of several degrees in the solar collectors due to the mounting of the collectors in series, and a reduction in head losses due to the association of the solar collectors in parallel.

The plurality of solar collectors is advantageously a plurality of planar solar collectors.

The cost of the unit is thus significantly reduced.

According to another advantageous embodiment of the invention, the first coolant circuit comprises at least one first heat exchanger cooperating with a heat/cool pump device, and the means forming the heat transfer fluid collection tank are connected to a second heat exchanger cooperating with the heat/cool pump device.

The addition of a heat/cool pump device thus makes it possible to increase the autonomy of the refrigeration unit for very low power consumption. In addition, the energy efficiency obtained with the heat/cool pump device is highly satisfactory if the heat evacuated by the device is recovered in order to heat the fluid contained in the means forming the heat transfer fluid collection tank.

According to another advantageous aspect, the first coolant circuit comprises at least means forming a coolant collection tank.

The storage of a volume of coolant thus makes it possible to compensate for insufficient refrigeration production of the unit with respect to the air conditioning requirements.

The absorption means preferably cooperate with at least a cooling tower.

An embodiment of the invention also relates to a method for operating a solar-powered refrigeration unit for an air conditioning system as described above, comprising the steps of:

circulating the heat transfer fluid in the plurality of solar collectors;

recording the temperature of the heat transfer fluid measured by the temperature sensor at the outlet of the plurality of solar collectors;

varying the operational flow rate of the circulator pump on the basis of the recorded temperature of the fluid measured by the temperature sensor at the outlet of the plurality of solar collectors;

transferring the heat transfer fluid to the boiler-forming means after it has circulated in the plurality of solar collectors;

circulating the coolant in the evaporator-forming means, then in the first heat exchanger.

An embodiment of the invention also relates to a method for startup of a solar-powered refrigeration unit for an air conditioning system as described above, comprising the steps of:

comparing the temperature of the heat transfer fluid measured by the temperature sensor at the outlet of the plurality of solar collectors to a first set point value;

turning on the circulator pump of the second heat transfer fluid circuit so that the operational flow rate is substantially equal to a first flow rate value if the temperature of the heat transfer fluid measured by the temperature sensor at the plurality of solar collectors is greater than the first set point value;

adjusting the operational flow rate of the circulator pump if the temperature of the heat transfer fluid measured by the temperature sensor at the plurality of solar collectors is greater than a second set point value according to a law of linear proportionality on the basis of the difference between the temperature of the heat transfer fluid measured by the temperature sensor at the outlet of the plurality of solar collectors and the second set point value;

maintaining the operational flow rate substantially at a maximum flow rate value if the temperature of the heat transfer fluid measured by the temperature sensor is greater than a third set point value;

actuating the at least one valve making it possible to reduce to a zero value the operational flow rate circulating in the second bypass branch if the temperature of the heat transfer fluid measured by the temperature sensor at the outlet of the plurality of solar collectors is greater than a fourth set point value.

Such a startup process thus enables rapid heating of the heat transfer fluid.

An embodiment of the invention also relates to a method for implementing a solar-powered refrigeration unit for an air conditioning system as described above, comprising the steps of:

acting on the circulator pump so that the operational flow rate of the circulator pump is substantially equal to a maximum flow rate value if the temperature of the heat transfer fluid measured by the temperature sensor at the outlet of the plurality of solar collectors is greater than or equal to the third set point value and below a safety set point value;

stopping the circulator pump if the temperature of the heat transfer fluid measured by the temperature sensor at the outlet of the plurality of solar collectors is below or equal to a fifth set point value;

acting on the circulator pump so that the operational flow rate of the circulator pump is greater than or equal to the first flow rate value and below the maximum flow rate value if the temperature of the heat transfer fluid measured by the temperature sensor at the outlet of the plurality of solar collectors is below the third set point value and greater than and/or equal to the second set point value.

Thus, the flow rate of the heat transfer fluid circulating in the solar collectors is adapted on the basis of the temperature of the heat transfer fluid at the outlet of the solar collectors in order to maintain this temperature for as long as possible above a minimum working temperature.

Preferably, the first flow rate value is between two-tenths and five-tenths the maximum flow rate value in the aforementioned steps of the methods for startup and implementation of the solar-powered refrigeration unit.

Advantageously, the third set point value is between 68 degrees Celsius and 90 degrees Celsius.

Such a temperature level is suitable for the use of an absorption machine and makes it possible to reduce heat losses in the second heat transfer fluid circuit given its moderate value.

An embodiment of the invention also relates to the aforementioned startup and implementation methods, so that the flow of fluid in the second bypass branch is cancelled if the temperature of the heat transfer fluid measured by the temperature sensor at the outlet of the plurality of sun collectors is greater than or equal to the fourth set point value.

Preferably, the fourth set point value is greater than or equal to the third set point value.

Thus, it is not possible to circulate some heat transfer fluid with a temperature below the third set point value to the boiler-forming means.

An embodiment of the invention also relates to a method for implementing a solar-powered refrigeration unit as described above, and which comprises the step of shifting the operational flow of the circulator pump into the second bypass branch if the temperature of the heat transfer fluid measured by the temperature sensor at the outlet of the plurality of solar collectors is below or equal to a sixth set point value below or equal to the third set point value.

Thus, the automatic system controls the changes in position of the at least one valve for two different temperatures separated by a temperature differential in order to prevent damage to the valve due to constant openings and closings, if the temperature of the heat transfer fluid varies according to periodic oscillations.

An embodiment of the invention also relates to a device for startup of a solar-powered refrigeration unit for an air conditioning system, in which the system comprises at least one first heat exchanger, and the solar-powered unit comprises:

absorption means comprising boiler-forming means and evaporator-forming means, in which the evaporator-forming means comprise at least one second heat exchanger and the boiler-forming means comprise at least one third heat-exchanger;

a plurality of solar collectors;

a first coolant circuit between the first heat exchanger and the second heat exchanger;

a second coolant circuit between the third heat exchanger and the plurality of solar collectors, in which the second circuit comprises at least one circulator pump supplying heat transfer fluid to the plurality of solar collectors, and at least one temperature sensor intended to measure the temperature of the heat transfer fluid at the outlet of the plurality of solar collectors, which second heat transfer circuit comprises at least one bypass with a first branch comprising at least the circulator pump and a second branch, and at least one valve acting on the flow rate of fluid circulating in the second branch of the bypass;

means for varying the operational flow rate of the circulator pump on the basis of the temperature of the fluid measured by the temperature sensor at the outlet of the plurality of solar collectors;

comprising:

means for comparing the temperature of the heat transfer fluid measured by the temperature sensor at the outlet of the plurality of solar collectors with a first set point value;

means for turning on the circulator pump of the second heat transfer fluid circuit so that the operational flow rate is substantially equal to a first flow rate value if the temperature of the heat transfer fluid measured by the temperature sensor at the plurality of solar collectors is greater than the first set point value;

means for adjusting the operational flow rate of the circulator pump if the temperature of the heat transfer fluid measured by the temperature sensor at the plurality of solar collectors is greater than a second set point value according to a law of linear proportionality on the basis of the difference between the temperature of the heat transfer fluid measured by the temperature sensor at the outlet of the plurality of solar collectors and the second set point value;

means for maintaining the operational flow rate substantially at a maximum flow rate value if the temperature of the heat transfer fluid measured by the temperature sensor is greater than a third set point value;

means for actuating the at least one valve making it possible to reduce to a zero value the operational flow rate circulating in the second branch of the bypass if the temperature of the heat transfer fluid measured by the temperature sensor at the outlet of the plurality of solar collectors is greater than a fourth set point value.

An embodiment of the invention also relates to a device for implementing a solar-powered refrigeration unit for an air conditioning system, in which the system comprises at least one first heat exchanger, which solar-powered unit comprises:

absorption means comprising boiler-forming means and evaporator-forming means, in which the evaporator-forming means comprise at least one second heat exchanger and the boiler-forming means comprise at least one third heat exchanger;

a plurality of solar collectors;

a first coolant circuit between the first heat exchanger and the second heat exchanger; and

a second heat transfer fluid circuit between the third heat exchanger and the plurality of solar collectors, in which the second circuit comprises at least one circulator pump supplying heat transfer fluid to the plurality of solar collectors, and at least one temperature sensor intended to measure the temperature of the heat transfer fluid at the outlet of the plurality of solar collectors;

means for varying the operational flow rate of the circulator pump on the basis of the temperature of the fluid measured by the temperature sensor at the outlet of the plurality of solar collectors;

comprising:

means for acting on the circulator pump so that the operational flow rate of the circulator pump is substantially equal to a maximum flow rate value if the temperature of the heat transfer fluid measured by the temperature sensor at the outlet of the plurality of solar collectors is greater than or equal to the third set point value and below a safety set point value;

means for stopping the circulator pump if the temperature of the heat transfer fluid measured by the temperature sensor at the outlet of the plurality of solar collectors is below or equal to a fifth set point value;

means for acting on the circulator pump so that the operational flow rate of the circulator pump is greater than or equal to the first flow rate value and below the maximum flow rate value if the temperature of the heat transfer fluid measured by the temperature sensor at the outlet of the plurality of solar collectors is below the third set point value and greater than and/or equal to the second set point value.

An embodiment of the invention also relates to a computer program that can be downloaded from a communication network and/or stored on a computer-readable medium and/or run by a microprocessor, comprising program code instructions for the execution of the steps of the startup method and/or the implementation methods described above, when it is run on a computer or on a self-contained control device.

### BRIEF DESCRIPTION OF THE DRAWINGS

Other features and advantages will become more clear on reading the following description of a preferred embodiment, given as an illustrative and non-limiting example, and the appended drawings in which:

FIG. 1 shows a block diagram of a solar-powered refrigeration unit according to a first embodiment of the invention;

FIG. 2 shows an embodiment of a network of solar collectors involved in an embodiment of the invention;

FIG. 3 shows the procedure for startup and operation of the unit according to an embodiment of the invention on the basis of the temperature of the heat transfer fluid at the outlet of the plurality of solar collectors;

FIG. 4 shows a block diagram of a solar-powered refrigeration unit comprising collection tank-forming means according to a second embodiment of the invention;

FIG. 5 shows a schematic diagram of a solar-powered refrigeration unit comprising a heat/cool pump device according to a third embodiment of the invention;

FIG. 6 shows an alternative of the block diagram shown in FIG. 4.

### DETAILED DESCRIPTION OF ILLUSTRATIVE EMBODIMENTS

It is noted that reference numbers common to all of the figures are used throughout the description in order to designate the same object or the same physical quantity.

The general principle of an embodiment of the invention lies in the use of solar energy to ensure coverage, in any season, of air conditioning requirements of premises, or a set of premises, during a time period extending at least partly over the diurnal period. An embodiment of the invention thus proposes a reliable, self-contained solar-powered refrigeration unit that is efficient and easy to implement.

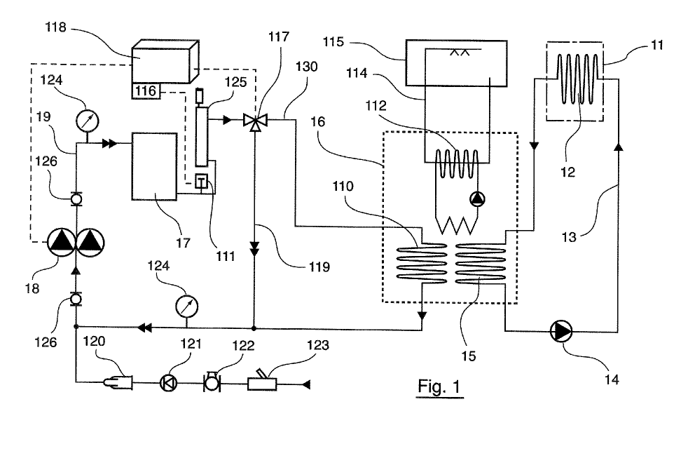

The block diagram of an embodiment of a solar-powered refrigeration unit according to an embodiment of the invention is shown in FIG. 1.

This unit according to an embodiment of the invention is intended to power fan-coil units of an air conditioning system 11. For the sake of clarity, only a first heat exchanger 12 belonging to one of the fan-coil units of the air conditioning system 11 is shown in the block diagram of FIG. 1. This first heat exchanger is connected to a first coolant circuit 13 forming a closed loop. Preferably, the coolant is glycol water. The production unit advantageously maintains the coolant at a temperature of between 4 and 12° C. (4 and 12 degrees Celsius) under established working conditions. A coolant circulator pump 14 enables circulation of the coolant in the first coolant circuit 13. The heat received by the coolant passing through the first heat exchanger 12 of the air conditioning system 11 is evacuated from the circuit by evaporator-forming means 15 of an absorption machine 16, also referred as evaporator, comprising a second heat exchanger.

The unit according to an embodiment of the invention also comprises a plurality of solar collectors 17 collecting solar energy, which is transmitted to a heat transfer fluid, and more specifically water in this embodiment, circulating by means of a circulator pump 18 in a second heat transfer fluid circuit 19 in order to supply heat to the boiler-forming means 110 of the absorption machine 16, also referred as boiler, comprising a third heat exchanger. The flow rate of fluid of the pump 18, all or some of which circulates in the plurality of solar collectors 17, is controlled on the basis of the temperature measured by the temperature sensor 111, placed at the outlet of the plurality of solar sensors.

In the remainder of the description, reference 111 will be used indifferently to designate the temperature sensor 11 and the temperature measured by said sensor.

The heat received by the boiler and the evaporator of the absorption machine is evacuated by the exchanger 112, which can be cooled by an air flow or by water circulation, for example belonging to the water circuit 114 of a cooling tower 115.

The fluids circulating in the absorption machine are preferably lithium bromide-water and ammonia-water.

In order to ensure a minimum temperature 116 of the fluid entering the boiler-forming means 110 of the second heat transfer fluid circuit 19, a three-way valve 117 is installed on the second heat transfer fluid circuit 19 between the plurality of solar collectors 17 and the boiler-forming means 110.

Advantageously, the control of the position of the valve 117 is managed by the automatic system 118.

The valve 117 thus directs the heat transfer fluid coming from the solar collectors in the branch 130 to the boiler-forming means 110 if the temperature 111 exceeds or is equal to the temperature 116, or returns said fluid to the inlet of the solar collectors via a circuit segment, also called a bypass 119, if the temperature is below the temperature 116. Preferably, the temperature 116 is greater than 70 degrees Celsius.

The second heat transfer fluid circuit comprises a portion of a water supply circuit, comprising a backflow preventer 120, a check valve 121, a pressure regulator 122 and a strainer 123.

Pressure sensors 124, or manometers, are arranged on the second heat transfer fluid circuit 19 so as to be capable of visually checking the pressure of the heat transfer fluid in the circuit.

A steam-liquid separator 125 equipped with a valve makes it possible to evacuate the residual steam circulating in the second heat transfer fluid circuit.

The twin circulator pump 18 used for preventing maintenance break and is equipped with anti-vibration isolation sections 126.

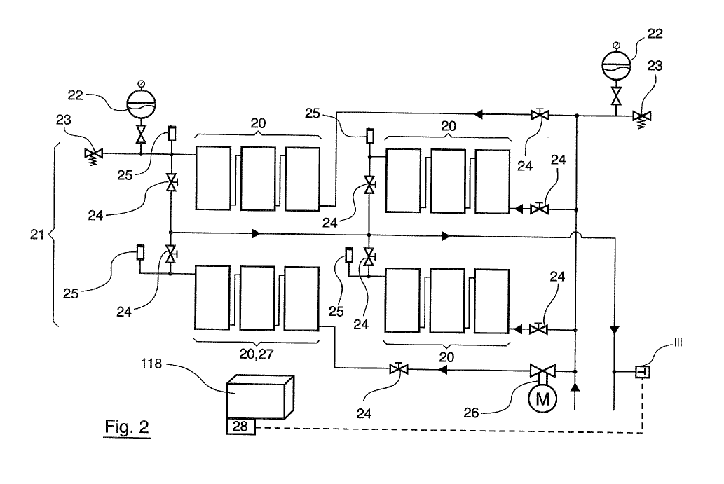

In a preferred embodiment, shown in FIG. 2, the plurality of solar collectors 17 is arranged according to a supply configuration combining the association of groups of solar collectors mounted in series 20 and in parallel 21. This arrangement enables a reduction in head losses, owing to the association of collectors in parallel, correlated with an appropriate increase in the working temperature, i.e. of several degrees, and the passage through the solar collectors, which is allowed for the series arrangement, without having to reduce the flow rate through the collectors. The solar collectors 20 and 21 are preferably chosen from the planar solar collectors, of which the purchasing cost remains acceptable.

Expansion tanks 22 are placed at the highest points of the circuit so that the solar collectors are always supplied with heat transfer fluid. In addition, expansion tanks 22 make it possible to evacuate the residual steam. Safety valves 23 mounted on the expansion tanks complete the safety equipment.

Manually actuated isolation valves 24 and automatic drain valves 25 are provided in each group of collectors arranged in series 20. Thus, it is possible to cut off the circulation of heat transfer fluid in any group of solar collectors 20 in order to perform maintenance operations or a replacement if a collector is damaged.

Since the solar-powered refrigeration unit is intended to work throughout the year, the number of solar collectors of the plurality of solar collectors installed is obtained in particular, but not exclusively, on the basis of forecasts based on the period of least sunshine, i.e. the winter period. In addition, and in any case, it is important to make sure that there is not an excessive number of solar collectors for the solar-powered unit according to an embodiment of the invention, so as to limit the cost price. In the summer period, since solar contributions are higher, there is a risk that the temperature of the heat transfer fluid will increase above the boiling point of the heat transfer fluid in the solar collectors and that steam will appear, inevitably leading to reduced efficiency of the collectors. Thus, a powered two-way valve 26 controlled on the basis of the temperature of the heat transfer fluid 111 at the outlet of the plurality of solar collectors is installed on the branch of the circuit supplying the group 27, in order to make it possible to cut the circulation of heat transfer fluid in its group 27 of solar collectors of the type mounted in series 20. When the temperature 111 goes above a safety set point temperature 28, the valve 26 closes, thereby increasing the flow rate of the heat transfer fluid in the other groups of solar collectors and consequently reducing the temperature 111.

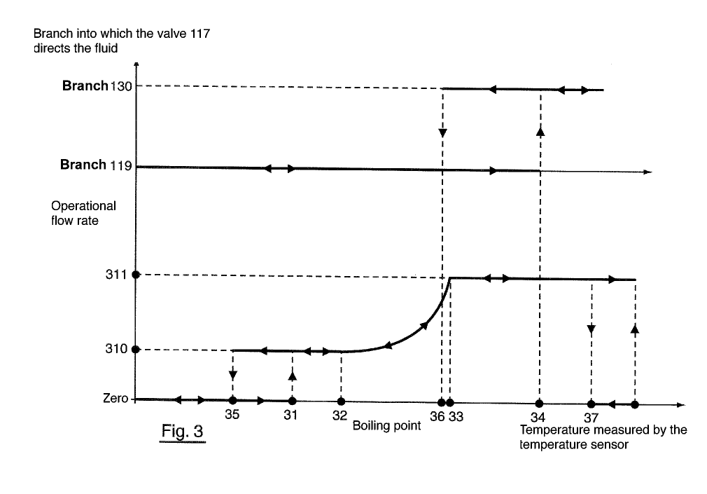

The sequence for startup of the system is presented in reference to FIG. 3. This procedure, controlled by the automatic system 118, makes it possible to significantly reduce the duration of the warm-up of the unit to a minimum working temperature 33, which corresponds to the minimum temperature at which the heat transfer fluid must arrive at the boiler-forming means 110 in order to enable the absorption means to function. The temperature 33 is advantageously between 68 and 90 degrees Celsius.

As soon as the sun rises, regardless of the cloud coverage, the temperature 111 rises at the outlet of the plurality of solar collectors. When this temperature 111 goes above a first set point value 31, the circulator pump 18 is automatically turned on and the heat transfer fluid begins to circulate in the plurality of solar collectors 17. In this first phase of the startup, the value of the operational flow rate of the pump 18 is set substantially at a first flow rate value 310 by the automatic system 118. Preferably, the first flow rate value 310 is between 20 and 50 percent of the maximum flow rate value 311, and is advantageously equal to 40 percent of the flow rate 311. In order to accelerate the warm-up of the solar collectors, the three-way valve 117 is positioned by the automatic system 118 so as to direct the heat transfer fluid into the branch of the bypass 119, in order to return the heat transfer fluid directly to the inlet of the solar collectors 17, without passing through the boiler-forming means 110.

When the temperature 111 goes above a second set point temperature 32, the automatic system acts on the pump so as to increase the operational flow rate of the pump 18, proportionally to the temperature difference between the temperature 111 and the temperature 32.

As soon as the temperature 111 reaches or goes above the third set point temperature, or the minimum working temperature 33, the operational flow rate of the pump 18 is now at its maximum value 311, also called the nominal flow rate value.

When the temperature 111 reaches or goes above a fourth set point temperature 34, the automatic system 118 sends a signal to change the position of the three-way valve 117 and the heat transfer fluid leaving the plurality of solar collectors 17 is directed toward the boiler-forming means 110.

Of course, it is necessary to provide a time delay system, or any other appropriate means, so as to prevent untimely stops and starts of the circulator pump 18 in the first phase of the startup. Indeed, since the entire volume of heat transfer fluid has cooled during the night, the temperature of the heat transfer fluid becomes uniform only after the heat transfer fluid has passed several times through the second heat transfer fluid circuit. For example, in this embodiment, in the case of insufficient solar contributions the circulator pump is stopped only if the temperature 111 goes below a fifth set point value 35, more than ten degrees Celsius below the first set point temperature 31.

In addition, safety features incorporated in the automatic system 118 make it possible to stop or prevent the startup of the circulator pump 18, in order to prevent damage to the system equipment. In particular, the boiler-forming means 110 can be damaged if the temperature in the branch at the inlet of the boiler-forming means goes above a threshold value. As already mentioned, the temperature of the fluid in the solar collectors can go above the boiling temperature of the fluid and cause the appearance of steam, in particular if the circulator pump is stopped and a volume of heat transfer fluid stagnates in the collectors. In this situation, the automatic system automatically commands the circulator pump 18 to stop, and this pump 18 is started again only if the heat transfer fluid has cooled sufficiently and the temperature of the coolant has gone below a value 37.

A timing programmer and/or a dusk-to-dawn switch can be associated with the solar-powered unit according to an embodiment of the invention in order to control the time of startup of the unit.

Under nominal working conditions (presented in reference to FIG. 3), in order to avoid frequent periodic turn-overs, also called pumping, of the three-way valve component 117 between its two positions, preferably, if the temperature 111 falls below the temperature 34, the three-way valve changes positions in order to redirect the heat transfer fluid directly to the inlet of the plurality of solar collectors only if the temperature goes below a temperature 36 a few degrees below temperature 34. Advantageously, the temperature differential between temperature 34 and temperature 36 is around 8 degrees Celsius.

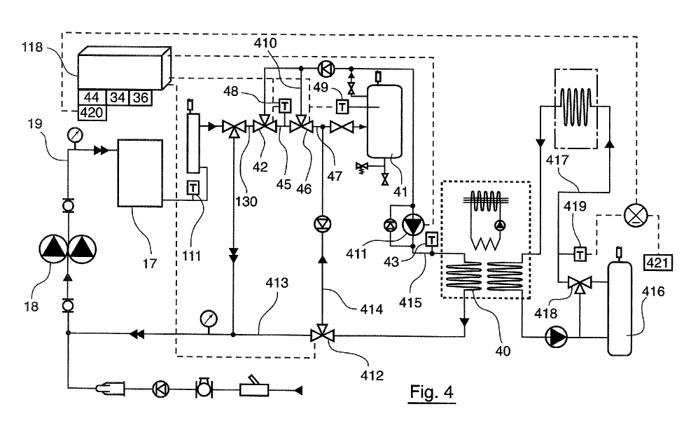

In a second embodiment of the invention, means forming a heat transfer fluid collection tank 41, also referred as the hot water storage tank, are installed on the heat transfer fluid circuit, as shown in FIG. 4. Such a storage tank is preferably arranged vertically.

This hot water storage tank 41 advantageously makes it possible to accelerate the temperature increase of the heat transfer fluid in the startup period, to overcome insufficient sunshine under working conditions, and to extend the period of operation of the solar-powered refrigeration unit, primarily at the end of the day.

It is possible to envisage, without going beyond the scope of the invention, that the heat transfer fluid contained in such a hot water storage tank 41 is used to preheat the boiler-forming means 110 of the absorption machine in the period of startup of the solar-powered refrigeration unit.

A three-way valve with progressive opening 42, also called a mixing valve, makes it possible to distribute the heat transfer fluid coming from the plurality of solar collectors 17 between the storage tank 41 and the boiler-forming means 110.

This valve 42 is controlled on the basis of the temperature measured by a temperature sensor 43, placed at the inlet of the boiler-forming means.

For a temperature measured by the temperature sensor 43 below a set point value 44, the mixing valve 42 directs the whole heat transfer fluid coming from the plurality of solar collectors 17 to the boiler-forming means 110.

When the temperature measured by the temperature sensor 43 is greater than or equal to the set point temperature 44, the mixing valve 42 allows the heat-transfer fluid coming from the plurality of solar collectors 17 to progressively pass into the circuit branch 45, toward the means forming a heat transfer fluid collection tank 110. Advantageously, the flow rate of the heat transfer fluid sent to the means forming the collection tank 41 varies linearly according to the difference between the temperature measured by the temperature sensor 43 and the set point temperature 44.

Preferably, a control unit 46 is installed between the mixing valve and the means forming a collection tank in order to prevent the heat transfer fluid coming from the plurality of solar collectors 17 from cooling the heat transfer fluid contained in the means forming the collection tank 41. Such a full-on/full-off three-way valve or unit 46 thus directs the heat transfer fluid into the branch 47 if the temperature in the branch measured by the temperature sensor 48 goes slightly above, i.e. by a few degrees, the average temperature 49 measured in the hot water storage tank 41, and into the branch 410 if the temperature in the branch measured by the temperature sensor 48 goes slightly below the temperature 49, i.e. by a few degrees.

The average temperature 49 measured in the hot water storage tank 41 is obtained from a sensor preferably placed in the upper portion of the storage tank or from a weighted average of a plurality of temperatures measured by a plurality of temperature sensors inserted into the tank 41 in order to locally measure the temperature of the heat transfer fluid.

In order to supply the boiler-forming means 110, from the hot water storage tank 41, with a heat transfer fluid having a suitable temperature when the temperature 111 at the outlet of the plurality of solar collectors is insufficient, i.e. below temperature 34, a second circulator pump 411, as well as a on/full-off three-way valve 412, are installed near the boiler-forming means 110.

In this embodiment, the second circulator pump 411 is placed in front of the boiler-forming means and the three-way valve 412 is placed after these same means, using, as a reference, the direction of circulation of the heat transfer fluid.

The pump 411, advantageously working with a constant flow rate in order to satisfy the heat transfer fluid requirements of the boiler-forming means 110, is started up for a temperature 49 of the heat transfer fluid contained in the storage tank greater than or equal to temperature 34 if the temperature 111 at the outlet of the plurality of solar collectors is below temperature 36. The automatic system 118 nevertheless intervenes to stop the pump 411 if the heat transfer fluid cools substantially, with the temperature 49 going a few degrees, and preferably two degrees, below temperature 36, or if the temperature 111 of the heat transfer fluid at the outlet of the plurality of solar collectors again goes above the set point temperature 34.

For safety, an alarm incorporated in the automatic system 118 prevents the second circulator pump 411 from starting up if the absorption means are stopped. In addition, the startup of the second circulator pump is also controlled by the programmer of the air conditioning system in the interest of saving energy.

The functioning of the valve 412 minors that of the valve 117. If the temperature 111 goes above the set point temperature 34, the valve 412 opens in order to direct the heat transfer fluid coming from the boiler-forming means 110 into the branch 413 so that the heat transfer fluid returns to the plurality of solar collectors 17. By contrast, if the temperature 111 goes below the set point temperature 34, the valve 412 closes and then directs the heat transfer fluid into the branch 414 toward the hot water storage tank 41.

The successive steps of the operation sequence of such an alternative of the invention are therefore:

the increase in temperature of the heat transfer fluid circulating in the sensors according to the startup sequence described above, coinciding with a preheating of the boiler-forming means 110 with the heat transfer fluid coming from the means forming a heat transfer fluid collection tank 41;

the opening of the three-way valve 117 enabling the heat transfer fluid to be distributed in the branch 130 and the heat transfer fluid coming from the plurality of solar collectors 17 to be distributed in the boiler-forming means 110;

the supply of the boiler-forming means 110 with a mixture of heat transfer fluids coming from the plurality of solar collectors and the hot water storage tank 41;

the supply of the boiler-forming means 110 with the heat transfer fluid coming exclusively from the tank 41.

In addition, it is also possible to envisage, without adversely affecting an embodiment of the invention, placing the valve 412 in the branch 415 between the outlet of the storage tank and the inlet of the boiler-forming means.

Also, to enable the air conditioning system to function in situations in which the refrigerating capacity produced by the unit according to an embodiment of the invention does not cover all of the air conditioning requirements, means forming a coolant collection tank 416 are installed on the branch 417 of the first circuit 13 supplying the first exchanger 12.

Thus, a three-way modulating valve 418 has been placed on the branch 417 in order to enable the storage of the coolant in the means forming the collection tank 416 as soon as the temperature measured by a temperature sensor 419 goes below a set point value 420.

The progressive opening of the valve 418 is controlled by the difference in temperature 421 between temperature 419 and temperature 420, and, for example, obeys a law of linear change on the basis of the temperature difference 421. In an advantageous alternative of this embodiment, the opening of the valve 418 is dependent on the temperature difference between the temperature 419 and the temperature 422 of the coolant inside the means forming a coolant collection tank 416.

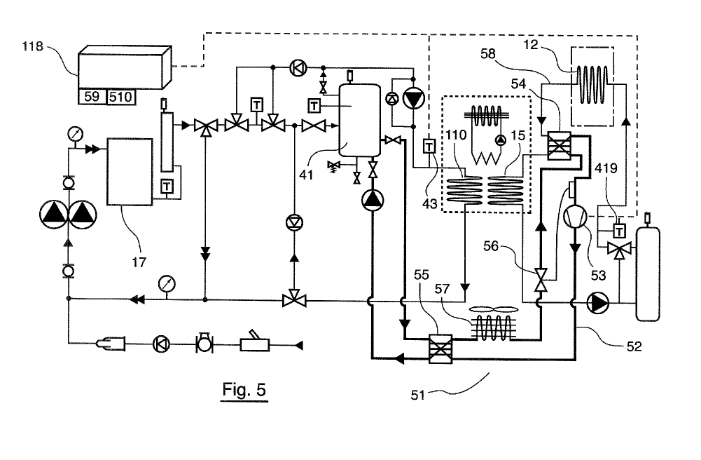

In another alternative of the invention shown in FIG. 5, the solar-powered refrigeration unit according to an embodiment of the invention comprises a heat/cool pump 51 in addition to the means forming the heat transfer fluid collection tank 41.

This device 51 provides added refrigeration making it possible to compensate for a lack of sunshine and/or allowing nocturnal operation of the air conditioning system, thereby increasing the autonomy of the unit while preventing a rupture in the refrigeration chain.

Careful use of such an added supply device 51 in a refrigeration unit according to an embodiment of the invention also makes it possible to recover a significant amount of energy. The heat/cool pump device 51 indeed makes it possible to heat the heat transfer fluid contained in the means forming the heat transfer fluid collection tank using the heat transferred by the condenser 55 of this device 51.

Another advantage of the heat/cool pump device 51 is that of comprising a sub-cooling step making it possible to obtain coefficients of performance (COP) or a ratio between the refrigerating capacity produced and the electrical power consumed, greater than 4, which is particularly beneficial at the energy level.

To optimize the general energy efficiency of the solar-powered refrigeration unit, the operation of the heat/cool pump device is advantageously limited over time, and more specifically to the period necessary for reheating the heat transfer fluid contained in the storage tank.

Such a device 51 comprises a refrigerant circuit 52, for example a R134A circuit, comprising a compressor 53, two heat exchangers (evaporator 54 and condenser 55), and a thermostatic regulator 56 accompanied by a third heat exchanger 57, also called a sub-cooler, making it possible to increase the cooling of the refrigerant.

For the embodiment shown in FIG. 5, the evacuation of heat from the sub-cooler is performed by air blowing.

The heat exchangers of the heat/cool pump device are of the plate heat exchanger type. However, any other type of heat exchanger allowing for good efficiency of the exchange can be envisaged in a solar-powered refrigeration unit according to an embodiment of the invention.

The evaporator 54 of the heat/cool pump device is arranged on the branch 58 of the first coolant circuit and cools the fluid leaving the first heat exchanger 12. Advantageously, the temperature of the refrigerant contained in the heat/cool pump device is substantially equal to 5 degrees Celsius in the evaporator and 95 degrees Celsius in the condenser.

The startup of the compressor 53 of the heat/cool pump device is controlled by the temperatures 419 and 43. The automatic system 118 transmits a command to startup the compressor if the temperature 43 is below or equal to a first set point temperature 59 and if the temperature 419 is greater than a second set point temperature 510. Preferably, the first set point temperature 59 is set at 70 degrees Celsius and the second set point temperature 510 is equal to 4 degrees Celsius.

The automatic system 118 also commands the stopping of the compressor 53 if:

the temperature 43 is greater than a third set point temperature 511, advantageously equal to 82 degrees Celsius; or

the temperature 419 is below or equal to the second set point temperature 510.

The heat/cool pump device is also provided with safety controls in order to maintain the pressure of the refrigerant at the outlet of the compressor 53 below an upper limit and the pressure of the refrigerant at the inlet of the compressor 53 above a lower limit. It also comprises a stop command in case an oil defect in the compressor 53.

According to yet another alternative of the invention, the circulator pump is controlled on the basis of a flow rate transmitter located in the branch of the second heat transfer fluid circuit located at the inlet of the boiler-forming means 110. The flow rate transmitter acts on the circulator pump 18 in order to maintain the flow rate of the heat transfer fluid passing through the boiler-forming means constant. According to this alternative, the flow rate of the pump is of course variable since the circulator pump also ensures the distribution of heat transfer fluid from the means forming the heat transfer fluid collection tank.

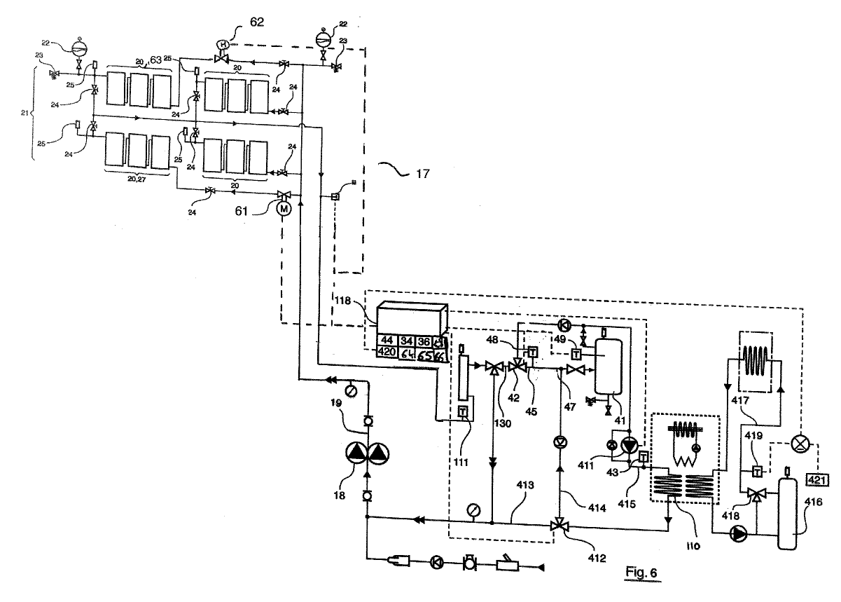

An alternative of the embodiment shown in FIG. 4 is shown in FIG. 6.

The implementation of this embodiment requires the portion of the second heat transfer fluid circuit comprising the plurality of solar collectors 17, shown in FIG. 6, to be provided with a first 61 and a second 62 powered full-on/full-off two-way valve acting on the flow rate of the heat transfer fluid circulating in the groups of solar collectors mounted in series 20 either allowing or preventing the circulation of the heat transfer fluid respectively in groups 27 and 63.

Indeed, it should be noted that the method of operation proposed for implementing this alternative is based on an original procedure that can be combined and/or substituted for the procedure presented in reference to FIGS. 3 and 4.

In addition, for the sake of clarity of FIG. 6, the control component 46 is not shown in this FIG. 6, since its integration thereof in the main diagram of FIG. 6 is fairly obvious from the explanations mentioned in this document regarding FIG. 4.

In this alternative of the embodiment shown in FIG. 4, the sequence for progressive safety, in steps, of the groups of collectors of the plurality of solar collectors 17 when the temperature 111 increases comprises the following three successive steps:

a step of closing the valve 61 when the temperature 111 reaches a first set point value 64;

a step of closing the valve 62 when the temperature 111 reaches a second set point value 65 above the set point value 64;

a step of making the entire installation safe by stopping the pump 18 when the temperature 111 reaches a critical set point temperature 65.

Thus by successively stopping the circulation of fluid in the groups of solar collectors 27, then 63, in the valve 61 and 62 closure steps, the flow rate is increased, and consequently the circulation speed of the heat transfer fluid circulating in the other groups of collectors 20, thereby making it possible to reduce, or reverse, the increase in temperature 111, nevertheless resulting in reduced heat exchange performances by these collectors.

When the plurality of collectors 17 is made safe and the pump 18 is therefore stopped, the circulator pump 411 is started up so as to continue to supply the boiler-forming means 110 of the absorption group by looping back to the hot water storage tank 41.

Means for controlling the flow circulating in each collector of a collector group, such as, for example, powered valves mounted at the inlet of each collector, can also be envisaged in another alternative of the embodiment of the unit shown in FIG. 6, substantially more improved, with a more gradual control.

The embodiment as well as the alternatives described here are not intended to limit the scope of the invention. Consequently, numerous modifications are possible without going beyond the scope of the invention as defined by the claims.

Thus, for example, the number and the features of the collectors, just like the number of collectors in each collector group and the number of powered three-way valves, can be adapted without affecting the generality of the invention.

In addition, it is possible to consider using the invention indifferently in the context of air conditioning or air refreshing systems.

In another aspect of the invention, it is also possible to implement a solar-powered heating unit for a heating system, which system comprises at least one first heat exchanger, comprising:

absorption means comprising boiler-forming means and evaporator-forming means, which evaporator-forming means comprise at least one second heat exchanger and the boiler-forming means comprise at least one third heat exchanger;

a plurality of solar collectors;

a first heat transfer fluid circuit between the first heat exchanger and the second heat exchanger; and

a second heat transfer fluid circuit between the second heat exchanger and the plurality of solar collectors, in which the second circuit comprises at least one circulator pump supplying heat transfer fluid to the plurality of solar collectors, and at least one temperature sensor intended to measure the temperature of the heat transfer fluid at the outlet of the plurality of solar collectors;

means for varying the operational flow rate of the circulator pump on the basis of the temperature of the fluid measured by the temperature sensor at the outlet of the plurality of solar collectors.

Such a heat production unit can in particular be implemented for heating premises located in a temperate climate region during the springtime, winter or autumnal periods.

The plurality of solar collectors of such a heat production unit can also comprise at least two solar collectors associated in series and at least two groups of solar collectors associated in parallel and/or at least one planar solar collector.

In addition, the second heat transfer fluid circuit can comprise means forming a heat transfer fluid collection tank, and, as the case may be, the first heat transfer fluid circuit of such a heat production unit can comprise at least one first heat exchanger cooperating with a heat/cool pump device, the means forming the heat transfer fluid collection tank being connected to a second heat exchanger cooperating with the heat/cool pump device.

More generally, the technical features and the methods described above, relating to a solar-powered refrigeration unit according to one or more embodiments of the invention can also be, at the very least partially, implemented in a heat production unit as described above, in particular by replacing the coolant with a heat transfer fluid.

An embodiment of the invention provides a self-contained solar-powered refrigeration unit, i.e. without an added heat supply system.

An embodiment of the invention provides a solar-powered refrigeration unit that is simple and less expensive to produce.

An embodiment of provides a solar-powered refrigeration unit for an air conditioning system that makes it possible to cover the air conditioning requirements of premises in the early period they are occupied.

An embodiment of the invention provides a solar-powered refrigeration unit that can work in any season.

An embodiment of the invention provides a solar-powered refrigeration unit with a reliable automated control system.

Although the present disclosure has been described with reference to one or more examples, workers skilled in the art will recognize that changes may be made in form and detail without departing from the scope of the disclosure and/or the appended claims.

1. Solar-powered refrigeration unit for an air conditioning system, which system comprises at least a first heat exchanger comprising:
absorption means comprising boiler-forming means and evaporator-forming means, in which the evaporator-forming means comprise at least a second heat exchanger and the boiler-forming means comprise at least a third heat exchanger;
a plurality of solar collectors;
a first coolant circuit between the first heat exchanger and the second heat exchanger; and
a second heat transfer fluid circuit between the third heat exchanger and the plurality of solar collectors, in which the second circuit comprises at least one circulator pump supplying heat transfer fluid to the plurality of solar collectors, and at least a temperature sensor intended to measure the temperature of the heat transfer fluid at the outlet of the plurality of solar collectors; and
means for varying the operational flow rate of the circulator pump on the basis of the temperature of the fluid measured by the temperature sensor at the outlet of the plurality of solar collectors.

2. Solar-powered refrigeration unit for an air conditioning system according to claim 1, wherein the second heat transfer fluid circuit comprises at least one bypass with a first branch comprising at least the circulator pump and a second branch, and at least one valve acting on the fluid flow circulating in the second branch of the bypass.

3. Solar-powered refrigeration unit for an air conditioning system according to claim 2, wherein the at least one valve belongs to the group comprising:
a cut-off valve; and
full-on/full-off three-way valve.

4. Solar-powered refrigeration unit for an air conditioning system according to claim 1, wherein the second heat transfer fluid circuit comprises at least means forming a heat transfer fluid collection tank, and at least a three-way valve with a progressive opening making it possible to distribute the operational flow rate between the boiler-forming means of the absorption means and means forming the heat transfer fluid collection tank.

5. Solar-powered refrigeration unit for an air conditioning system according to claim 4, wherein the second heat transfer fluid circuit comprises at least a second circulator pump making it possible to circulate the heat transfer fluid from the means forming the heat transfer fluid collection tank to the boiler-forming means.

6. Solar-powered refrigeration unit for an air conditioning system according to claim 1, wherein the plurality of solar collectors comprises at least two solar collectors associated in series and at least two groups of solar collectors associated in parallel.

7. Solar-powered refrigeration unit for an air conditioning system according to claim 1, wherein the plurality of solar collectors comprises a plurality of planar solar collectors.

8. Solar-powered refrigeration unit for an air conditioning system according to claim 4, wherein the first coolant circuit comprises at least one first heat exchanger cooperating with a heat/cool pump device, and the means forming the heat transfer fluid collection tank are connected to a second heat exchanger cooperating with the heat/cool pump device.

9. Solar-powered refrigeration unit for an air conditioning system according to claim 1, wherein the first coolant circuit comprises at least means forming a coolant collection tank.

10. Solar-powered refrigeration unit for an air conditioning system according to claim 1, wherein the absorption means cooperate with at least a cooling tower.

11. Method for operating a solar-powered refrigeration unit for an air conditioning system, which system comprises at least one first heat exchanger comprising absorption means comprising boiler-forming means and evaporator-forming means, in which the evaporator-forming means comprise at least one second heat exchanger and the boiler-forming means comprise at least one third heat exchanger, a plurality of solar collectors, a first coolant circuit between the first heat exchanger and the second heat exchanger and a second heat transfer fluid circuit between the third heat exchanger and the plurality of solar collectors, in which the second circuit comprises at least one circulator pump supplying heat transfer fluid to the plurality of solar collectors, and at least one temperature sensor intended to measure the temperature of the heat transfer fluid at the outlet of the plurality of solar collectors, comprising the steps of:
circulating the heat transfer fluid in the plurality of solar collectors;
recording the temperature of the heat transfer fluid measured by the temperature sensor at the outlet of the plurality of solar collectors;
varying the operational flow rate of the circulator pump on the basis of the recorded temperature of the fluid measured by the temperature sensor at the outlet of the plurality of solar collectors;
transferring the heat transfer fluid to the boiler-forming means after it has circulated in the plurality of solar collectors;
circulating the coolant in the evaporator-forming means, then in the first heat exchanger.

12. Method for startup of a solar-powered refrigeration unit for an air conditioning system, which comprises at least a first heat exchanger comprising:
absorption means comprising boiler-forming means and evaporator-forming means, in which the evaporator-forming means comprise at least a second heat exchanger and the boiler-forming means comprise at least a third heat exchanger;
a plurality of solar collectors;
a first coolant circuit between the first heat exchanger and the second heat exchanger; and
a second heat transfer fluid circuit between the third heat exchanger and the plurality of solar collectors, in which the second circuit comprises at least one circulator pump supplying heat transfer fluid to the plurality of solar collectors, and at least a temperature sensor intended to measure the temperature of the heat transfer fluid at the outlet of the plurality of solar collectors; and
means for varying the operational flow rate of the circulator pump on the basis of the temperature of the fluid measured by the temperature sensor at the outlet of the plurality of solar collectors.
wherein the second heat transfer fluid circuit comprises at least one bypass with a first branch comprising at least the circulator pump and a second branch, and at least one valve acting on the fluid flow circulating in the second branch of the bypass,
the method comprising the steps of:
comparing the temperature of the heat transfer fluid measured by the temperature sensor at the outlet of the plurality of solar collectors to a first set point value;
turning on the circulator pump of the second heat transfer fluid circuit so that the operational flow rate is substantially equal to a first flow rate value if the temperature of the heat transfer fluid measured by the temperature sensor at the outlet of the plurality of solar collectors is greater than the first set point value;
adjusting the operational flow rate of the circulator pump if the temperature of the heat transfer fluid measured by the temperature sensor at the outlet of the plurality of solar collectors is greater than a second set point value according to a law of linear proportionality on the basis of the difference between the temperature of the heat transfer fluid measured by the temperature sensor at the outlet of the plurality of solar collectors and the second set point value;
maintaining the operational flow rate substantially at a maximum flow rate value if the temperature of the heat transfer fluid measured by the temperature sensor is greater than a third set point value;
actuating the at least one valve making it possible to reduce to a zero value the operational flow rate circulating in the second branch of the bypass branch if the temperature of the heat transfer fluid measured by the temperature sensor at the outlet of the plurality of solar collectors is greater than a fourth set point value.

13. Method for implementing a solar-powered refrigeration unit for an air conditioning system, which comprises at least a first heat exchanger comprising:
absorption means comprising boiler-forming means and evaporator-forming means, in which the evaporator-forming means comprise at least a second heat exchanger and the boiler-forming means comprise at least a third heat exchanger;
a plurality of solar collectors;
a first coolant circuit between the first heat exchanger and the second heat exchanger; and
a second heat transfer fluid circuit between the third heat exchanger and the plurality of solar collectors, in which the second circuit comprises at least one circulator pump supplying heat transfer fluid to the plurality of solar collectors, and at least a temperature sensor intended to measure the temperature of the heat transfer fluid at the outlet of the plurality of solar collectors; and
means for varying the operational flow rate of the circulator pump on the basis of the temperature of the fluid measured by the temperature sensor at the outlet of the plurality of solar collectors,
the method comprising the steps of:
acting on the circulator pump so that the operational flow rate of the circulator pump is substantially equal to a maximum flow rate value if the temperature of the heat transfer fluid measured by the temperature sensor at the outlet of the plurality of solar collectors is greater than or equal to the third set point value and below a safety set point value;
stopping the circulator pump if the temperature of the heat transfer fluid measured by the temperature sensor at the outlet of the plurality of solar collectors is below or equal to a fifth set point value;
acting on the circulator pump so that the operational flow rate of the circulator pump is greater than or equal to the first flow rate value and below the maximum flow rate value if the temperature of the heat transfer fluid measured by the temperature sensor at the outlet of the plurality of solar collectors is below the third set point value and greater than and/or equal to the second set point value.

14. Method for implementing a solar-powered refrigeration unit according to claim 13, wherein in the step of acting on the circulator pump so that the operational flow rate of the circulator pump is greater than or equal to the first flow rate value and below the maximum flow rate value, the first flow rate value is between two-tenths and five-tenths the maximum flow rate value.

15. Method for implementing a solar-powered refrigeration unit for an air conditioning system according to claim 13, wherein in the step of acting on the circulator pump so that the operational flow rate of the circulator pump is substantially equal to a maximum flow rate value, the third set point value is between 68 degrees Celsius and 90 degrees Celsius.

16. Method for implementing a solar-powered refrigeration unit for an air conditioning system according to claim 13, further comprising the step of cancelling the flow of fluid in the second branch of the bypass if the temperature of the heat transfer fluid measured by the temperature sensor at the outlet of the plurality of sun collectors is greater than or equal to the fourth set point value.

17. Method for implementing a solar-powered refrigeration unit for an air conditioning system according to claim 16, wherein in the step of cancelling the flow of fluid in the second branch of the bypass, the fourth set point value (34) is greater than or equal to the third set point value.

18. Method for implementing a solar-powered refrigeration unit for an air conditioning system according to claim 16, further comprising the step of shifting the operational flow of the circulator pump into the second branch of the bypass if the temperature of the heat transfer fluid measured by the temperature sensor at the outlet of the plurality of solar collectors is below or equal to a sixth set point value below or equal to the third set point value.

19. Device for startup of a solar-powered refrigeration unit for an air conditioning system according to claim 2, comprising:
means for comparing the temperature of the heat transfer fluid measured by the temperature sensor at the outlet of the plurality of solar collectors with a first set point value;
means for turning on the circulator pump of the second heat transfer fluid circuit so that the operational flow rate is substantially equal to a first flow rate value if the temperature of the heat transfer fluid measured by the temperature sensor at the plurality of solar collectors is greater than the first set point value;
means for adjusting the operational flow rate of the circulator pump if the temperature of the heat transfer fluid measured by the temperature sensor at the outlet of the plurality of solar collectors is greater than a second set point value according to a law of linear proportionality on the basis of the difference between the temperature of the heat transfer fluid measured by the temperature sensor at the outlet of the plurality of solar collectors and the second set point value;
means for maintaining the operational flow rate substantially at a maximum flow rate value if the temperature of the heat transfer fluid measured by the temperature sensor is greater than a third set point value;
means for actuating the at least one valve making it possible to reduce to a zero value the operational flow rate circulating in the second branch of the bypass if the temperature of the heat transfer fluid measured by the temperature sensor at the outlet of the plurality of solar collectors is greater than a fourth set point value.

20. Device for implementing a solar-powered refrigeration unit for an air conditioning system according to claim 1, comprising:
means for acting on the circulator pump so that the operational flow rate of the circulator pump is substantially equal to a maximum flow rate value if the temperature of the heat transfer fluid measured by the temperature sensor at the outlet of the plurality of solar collectors is greater than or equal to the third set point value and below a safety set point value;
means for stopping the circulator pump if the temperature of the heat transfer fluid measured by the temperature sensor at the outlet of the plurality of solar collectors is below or equal to a fifth set point value;
means for acting on the circulator pump so that the operational flow rate of the circulator pump is greater than or equal to the first flow rate value and below the maximum flow rate value if the temperature of the heat transfer fluid measured by the temperature sensor at the outlet of the plurality of solar collectors is below the third set point value and greater than and/or equal to the second set point value.

21. Computer program stored on a computer-readable medium, comprising program code instructions for execution of a method for startup of a solar-powered refrigeration unit for an air conditioning system, when it is run on a computer or on a self-contained control device, wherein the unit comprises at least a first heat exchanger comprising:
absorption means comprising boiler-forming means and evaporator-forming means, in which the evaporator-forming means comprise at least a second heat exchanger and the boiler-forming means comprise at least a third heat exchanger;
a plurality of solar collectors;
a first coolant circuit between the first heat exchanger and the second heat exchanger; and
a second heat transfer fluid circuit between the third heat exchanger and the plurality of solar collectors, in which the second circuit comprises at least one circulator pump supplying heat transfer fluid to the plurality of solar collectors, and at least a temperature sensor intended to measure the temperature of the heat transfer fluid at the outlet of the plurality of solar collectors; and
means for varying the operational flow rate of the circulator pump on the basis of the temperature of the fluid measured by the temperature sensor at the outlet of the plurality of solar collectors.
wherein the second heat transfer fluid circuit comprises at least one bypass with a first branch comprising at least the circulator pump and a second branch, and at least one valve acting on the fluid flow circulating in the second branch of the bypass,
the method comprising the steps of:
comparing the temperature of the heat transfer fluid measured by the temperature sensor at the outlet of the plurality of solar collectors to a first set point value;
turning on the circulator pump of the second heat transfer fluid circuit so that the operational flow rate is substantially equal to a first flow rate value if the temperature of the heat transfer fluid measured by the temperature sensor at the outlet of the plurality of solar collectors is greater than the first set point value;
adjusting the operational flow rate of the circulator pump if the temperature of the heat transfer fluid measured by the temperature sensor at the outlet of the plurality of solar collectors is greater than a second set point value according to a law of linear proportionality on the basis of the difference between the temperature of the heat transfer fluid measured by the temperature sensor at the outlet of the plurality of solar collectors and the second set point value;
maintaining the operational flow rate substantially at a maximum flow rate value if the temperature of the heat transfer fluid measured by the temperature sensor is greater than a third set point value;
actuating the at least one valve making it possible to reduce to a zero value the operational flow rate circulating in the second branch of the bypass branch if the temperature of the heat transfer fluid measured by the temperature sensor at the outlet of the plurality of solar collectors is greater than a fourth set point value.

22. Computer program stored on a computer-readable medium, comprising program code instructions for execution of a method for startup of a solar-powered refrigeration unit for an air conditioning system, when it is run on a computer or on a self-contained device, wherein the unit comprises at least a first heat exchanger comprising:
absorption means comprising boiler-forming means and evaporator-forming means, in which the evaporator-forming means comprise at least a second heat exchanger and the boiler-forming means comprise at least a third heat exchanger;
a plurality of solar collectors;
a first coolant circuit between the first heat exchanger and the second heat exchanger; and
a second heat transfer fluid circuit between the third heat exchanger and the plurality of solar collectors, in which the second circuit comprises at least one circulator pump supplying heat transfer fluid to the plurality of solar collectors, and at least a temperature sensor intended to measure the temperature of the heat transfer fluid at the outlet of the plurality of solar collectors; and
means for varying the operational flow rate of the circulator pump on the basis of the temperature of the fluid measured by the temperature sensor at the outlet of the plurality of solar collectors,
the method comprising the steps of:
acting on the circulator pump so that the operational flow rate of the circulator pump is substantially equal to a maximum flow rate value if the temperature of the heat transfer fluid measured by the temperature sensor at the outlet of the plurality of solar collectors is greater than or equal to the third set point value and below a safety set point value;
stopping the circulator pump if the temperature of the heat transfer fluid measured by the temperature sensor at the outlet of the plurality of solar collectors is below or equal to a fifth set point value;
acting on the circulator pump so that the operational flow rate of the circulator pump is greater than or equal to the first flow rate value and below the maximum flow rate value if the temperature of the heat transfer fluid measured by the temperature sensor at the outlet of the plurality of solar collectors is below the third set point value and greater than and/or equal to the second set point value.
